(19) United States
(12) Patent Application Publication
(10) Pub. No.: US 2011/0146439 A1
(43) Pub. Date: Jun. 23, 2011

(54) PARKING LOCK DEVICE HAVING AN EMERGENCY OPERATION DEVICE FOR VEHICLE TRANSMISSIONS

(75) Inventors: Martin SAITNER, Berkheim (DE); Martin HOFFMANN, Eriskirch (DE); Florian KLEIN, Friedrichshafen (DE)

(73) Assignee: ZF FRIEDRICHSHAFEN AG, Friedrichshafen (DE)

(21) Appl. No.: 12/940,356

(22) Filed: Nov. 5, 2010

(30) Foreign Application Priority Data
Dec. 17, 2009 (DE) 10 2009 054 874.2

(51) Int. Cl. F16H 63/36

(52) U.S. Cl. 74/473.25

(57) ABSTRACT

A parking lock mechanism for a transmission which comprises a mechanical locking device, a movable thrust element that is connected to the mechanical locking device such that the thrust element can move the locking device between locked and unlocked conditions. The lock mechanism includes a parking lock actuation device with a first movable output element, an emergency actuation device with a second movable output element, and a first elastic element. The first output element is connected, via the first elastic element, to the thrust element so that movement of the first output element can be transmitted, via the first elastic element, to the thrust element, and the second output element is directly connected to the thrust element. The thrust element has a recess in which one side of the elastic element contacts a first wall of the recess and another side of the elastic element contacts the first output element.

This application claims priority from German patent application serial no. 10 2009 054 874.2 filed Dec. 17, 2009.

### FIELD OF THE INVENTION

The invention concerns a parking lock device having an emergency operation device for vehicle transmissions.

### BACKGROUND OF THE INVENTION

Such parking lock mechanisms are, as a rule, integrated in a vehicle transmission and/or act, in most cases with positive interlock, directly on a component of the vehicle transmission. They serve above all to secure a vehicle against unintentional rolling, for example when the vehicle is stopped or parked on an incline. For this, the parking lock mechanism has a parking lock actuation device by means of which a vehicle operator or an automatic operating system can issue a command to engage of disengage the parking lock mechanism. This command can be transmitted to the parking lock mechanism mechanically or electrically, with the effect that a mechanical locking device of the parking lock mechanism is actuated in an engagement of disengagement direction. When the mechanical locking device has been actuated in the disengagement direction and is in an unlocking condition, the parking lock mechanism is in a switched-off state in which the vehicle is not secured against rolling, whereas when the mechanical locking device has been actuated in the engagement direction and is in a locking condition, the parking lock mechanism is switched on and the vehicle is secured against rolling.

A mechanical locking device for parking lock mechanisms of vehicle transmissions is known, for example, from DE 3537091 C1.

In the event that the parking lock actuation device fails, it is no longer possible to actuate the mechanical locking device easily, so that disengaging it, for example in order to tow the vehicle away, or engaging it, for example in order to hold the vehicle steady on a downhill slope, are made more difficult. Accordingly, from the prior art, parking lock mechanisms with an emergency actuation device are known, which enable the mechanical locking device to be actuated even in such an emergency situation. Thus, the parking lock actuation device serves to actuate the parking lock mechanism in the normal case, i.e. during regular operation of the parking lock mechanism, whereas in contrast the emergency actuation device serves to actuate the parking lock mechanism in an emergency situation, i.e. other than during regular operation of the parking lock mechanism, such an emergency situation arising if, for example, there is a mechanical or electrical failure of the parking lock actuation device.

A parking lock mechanism with an emergency actuation device is known from DE 44 22 257 C1. This device has an electric motor which moves a selector spindle in translation, this in turn pushing a locking pawl of the parking lock mechanism, via a spring, to a locking or unlocked position, whereby the switched condition of the parking lock mechanism can be changed. If the parking lock mechanism is in its engaged switching condition, i.e. if the locking pawl is in a locking position, an unlocking lever can be actuated by pulling a handle, which pushes the locking pawl to its unlocked position whereby the switch condition of the parking lock mechanism changes from the engaged switching state to the disengaged switching state.

The parking lock mechanism known from DE 44 22 257 C1 has an extra, unlocking lever for the emergency actuation device, and no further design details of the parking lock mechanism are disclosed, in particular no more exact information is given about the design of the connection of the unlocking lever to the parking lock pawl or that of the selector spindle to the parking lock pawl.

### SUMMARY OF THE INVENTION

The purpose of the present invention is therefore to provide a simply designed parking lock mechanism with an emergency actuation device.

This objective is achieved by a parking lock mechanism for a vehicle transmission, which comprises as a minimum the following:
mechanical locking device,
a movable thrust element, actively connected to the mechanical locking device in such manner that when moved to a first position it moves the mechanical locking device to an unlocked state and when moved to a second position it moves the mechanical locking device to a locked state,
a parking lock actuation device with a first movable output element,
an emergency actuation device with a second movable output element, and
a first elastic element.

The first output element is connected by the first elastic element to the thrust element so that movement of the first output element can be transmitted via the first elastic element to the thrust element, and the second output element is connected directly to the thrust element so that movement of the second output element can be transmitted directly to the thrust element.

According to the invention, the thrust element has a recess in which the first elastic element is arranged at least in part, such that with a first side, in particular a first end side, it contacts a first wall of the recess and with an opposite second side, in particular a second end side, it contacts the first output element. The elastic element can also be connected fast to the thrust element and/or the first output element by additional means, as for example fixing screws, welding or clamping, and be fixed in the recess.

By virtue of the invention the movement of the output element of the emergency actuation device, namely the second output element, is transmitted to the thrust element without the need for a separate unlocking lever. Furthermore, the parking lock mechanism according to the invention can be made very compact since the elastic element is arranged in the recess of the thrust element. The first elastic element, which can in particular preferably be a helical spring, a cup spring, a ring spring or a volute spring, is in this case arranged and able to move on the first output element, whereby the parking lock mechanism takes up a particularly small space.

In this case the first output element consists of the component or components of the parking lock actuation device which is/are directly connected via the first elastic element to the thrust element. Correspondingly, the second output element consists of the component(s) of the emergency actuation device which is/are directly connected to the thrust element. In particular, the output elements can be inexpensive thrust rods or Bowden cables.

In a preferred design of the invention the thrust element rod is connected to a selector disk for selecting the gears or gear ratios of the vehicle transmission, this selector disk being connected to the mechanical locking device. This is particularly advantageous when the parking lock actuation device is integrated in a gear selection or gear ratio selection device for the operator of the vehicle, since then both the parking lock mechanism and the selector disk for selecting the gears or gear ratios of the vehicle transmission can be actuated by the parking lock actuation device.

In a further preferred design of the invention, an end area of the first output element is arranged between the elastic element and a second wall of the recess opposite the first wall thereof, in such manner that movement of the first output element in a first direction can be transmitted to the thrust element via the elastic element, and movement of the first output element in a second direction can be transmitted directly by the second wall to the thrust element. In this version, if the thrust element is now actively connected to the mechanical locking device in such manner that when moved in the first direction it actuates the latter in the engagement direction, then if the parking lock actuation device fails the parking lock mechanism can reliably be brought from the engaged switching state to the disengaged switching state. However, in this version, if the thrust element is actively connected to the mechanical locking device so that a movement in the first direction actuates it in the disengagement direction, then if the parking lock actuation device fails the parking lock mechanism can reliably be brought from the disengaged switching state to the engaged switching state. In this way the thrust element can be of simple structure and no additional components are needed for transmitting the movement of the first output element in the second direction.

In another preferred design of the parking lock mechanism, it has a second elastic element arranged at least partially in the recess of the thrust element, which with a first side, in particular a first end side, is in contact with a second wall of the recess opposite the first wall thereof, and with a second side, in particular a second end side, in contact with the first output element. An end area of the first output element is positioned between the first and second elastic elements in such a manner that movement of the first output element in a first direction can be transmitted at least in part by the first elastic element to the thrust element, and movement in a second direction can be transmitted at least in part by the second elastic element to the thrust element. In this way the switching condition of the parking lock mechanism in the event of a failure of the parking lock actuation device can be reliably changed by the emergency actuation device, both from a disengaged switching position to an engaged one and from an engaged switching position to a disengaged one.

Analogously to the first elastic element, the second elastic element is, in particular, a helical spring, a cup spring, a ring spring or a volute spring.

The parking lock actuating device and/or the emergency actuation device can comprise one or more actuators for moving the first output element or the second output element, whereby the force required for producing the movement does not have to be applied by an operator of the vehicle. The actuator or actuators can be designed in particular as hydraulic, pneumatic or electro-mechanical actuators, hydraulic or pneumatic actuators being suitable when the vehicle already has a suitable hydraulic or pneumatic system for other purposes, while in contract electro-mechanical actuators are appropriate when the vehicle has a powerful on-board power supply system, as for example in a hybrid vehicle or a purely electric vehicle.

Of course the parking lock actuation device and/or the emergency actuation device can also be designed such that movement of the first or second output element is produced manually by a vehicle operator, for example if the parking lock actuation device or the emergency actuation device has a lever that can be shifted by the vehicle operator, which is connected to the output element concerned and moves it when it is shifted. This enables the parking lock actuation device or the emergency actuation device to be actuated even if the vehicle's energy system has failed completely. Preferably, the parking lock actuation device has an actuator that enables the first output element to be moved comfortably in normal situations and the emergency actuation device has means that can be operated manually to move the second output element in an emergency situation.

Particularly preferably, the parking lock mechanism is used for a transmission of a passenger or utility vehicle, in particular for an automatic transmission or an automated gearshift transmission or a dual-clutch transmission of a passenger or a utility vehicle.

### BRIEF DESCRIPTION OF THE DRAWINGS

Below, the invention is explained in more detail with reference to figures in which further advantageous design features can be seen. The figures show, represented schematically in each case:

FIG. 1: Part of a parking lock mechanism;

FIG. 2: The part of the parking lock mechanism shown in FIG. 1, with its emergency actuation device activated;

FIG. 3: An alternative design of the thrust element, with two elastic elements;

FIG. 4: A parking lock mechanism, with a mechanical locking device in the disengaged switching condition

### DETAILED DESCRIPTION OF THE PREFERRED EMBODIMENTS

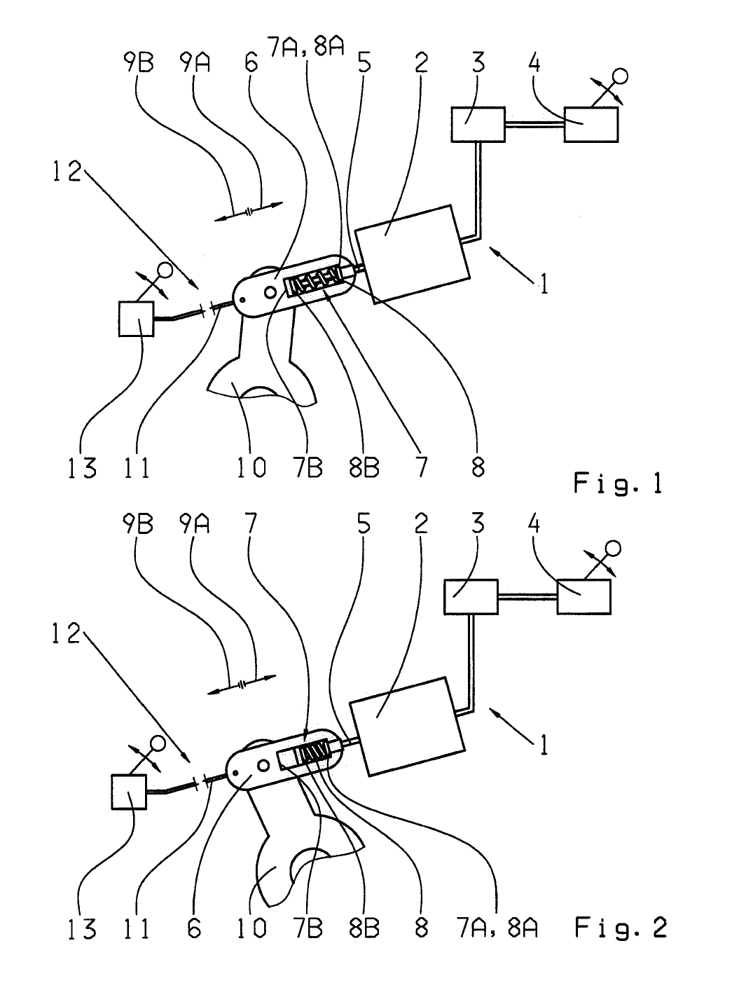

The part of a parking lock mechanism according to the invention shown in FIGS. 1 and 2 has a parking lock actuation device 1 with an actuator 2, an electronic regulator or control unit 3 connected electrically to the actuator 2 and a hand-lever 4 connected to the electronic regulator or control unit 3, by means of which a vehicle operator can issue a command to the regulator or control unit 3 to actuate the parking lock mechanism in the disengagement or engagement direction. Alternatively the command can also be triggered automatically by the regulator or control unit 3 without action by the vehicle operator, for example in the context of an automatic hill-starting aid. The actuator 2 comprises a first output element 5 in the form of a thrust rod that can move in translation, by which a thrust element 6 of the parking lock mechanism can be moved. For this purpose the thrust element 6 has a recess 7 into which the first output element 5 is inserted and can move through a bore leading into the recess 7, and an elastic element 8 like a compression spring arranged at least partially within the recess 7. The elastic element 8 is arranged and can move on the first output element 5, and is in contact with a first end side 8A against a first wall 7A of the recess, and with an opposite, second end side 8B against a thicker end area of the first output element 5. The end of the first output element 5 is pressed by prestressing the elastic element 8 against the second wall 7B of the recess 7 opposite its first wall 7A. Consequently, movement of the first output element 5 in a first direction 9A can be transmitted by the first elastic element 8 to the thrust element 6 and movement in a second direction 9B can be transmitted to the thrust element 6 directly by the second wall 7B. In turn, the thrust element 6 is connected by a hinge joint (not shown) to an arm of a rotary element 10, which is part of a mechanical locking device shown in more detail in FIG. 4.

To those with knowledge of the field it is clear that the recess 7 can be integrated in the thrust element 6 in any desired manner, for example by means of a cover that can be sealed shut. Correspondingly, the recess 7 can also be such that it encloses the elastic element 8 only on three sides, namely with the first and second walls 7A, 7B and a wall along the elastic element 8.

In addition the parking lock mechanism has an emergency actuation device 12, comprising a further hand-lever 13 and a second output element 11 made as a Bowden cable, which can be moved in translation by the further hand-lever 13 and whose end is connected directly to the thrust element 6.

In the event that due to a failure of the parking lock mechanism shown in FIG. 1 it now happens that the first output element 5 can no longer be moved, for example owing to a failure of the signal or energy supply to the actuator 2, the emergency actuation device 12 can still move the thrust element 6 in the second direction 9B, in that using the further hand-lever 13 the vehicle operator exerts a pulling force on the second output element 11 sufficient to move the thrust element 6 against the spring force of the elastic element 8. As shown in FIG. 2, the thrust element 6 then moves in the second direction so that the end of the first output element 5 moves clear of the second wall 7B of the recess 7 and the rotary element 10 is rotated by the thrust element 6. This then changes the parking lock mechanism either from the engaged shift condition to the disengaged shift condition or from the disengaged to the engaged shift condition, depending on whether the parking lock mechanism is designed either such that it adopts the disengaged condition when the thrust element 6 moves in the first direction 9A, or such that is adopts the disengaged condition when the thrust element 6 moves in the second direction 9B.

Preferably, however the emergency actuation device 12 is used to change the engaged condition to the disengaged condition, for example to enable the vehicle to be towed away in emergency, and for that reason the parking lock mechanism is preferably designed such that it adopts the disengaged condition when the thrust element 6 moves in the second direction 9B.

Alternatively to the further hand-lever 13, the emergency actuation device 12 can also have an actuator which moves the second output element 11, and the actuator 2 and the regulator or control unit 3 can be omitted if actuation of the hand-lever 4 brings about movement of the first output element 5 purely mechanically.

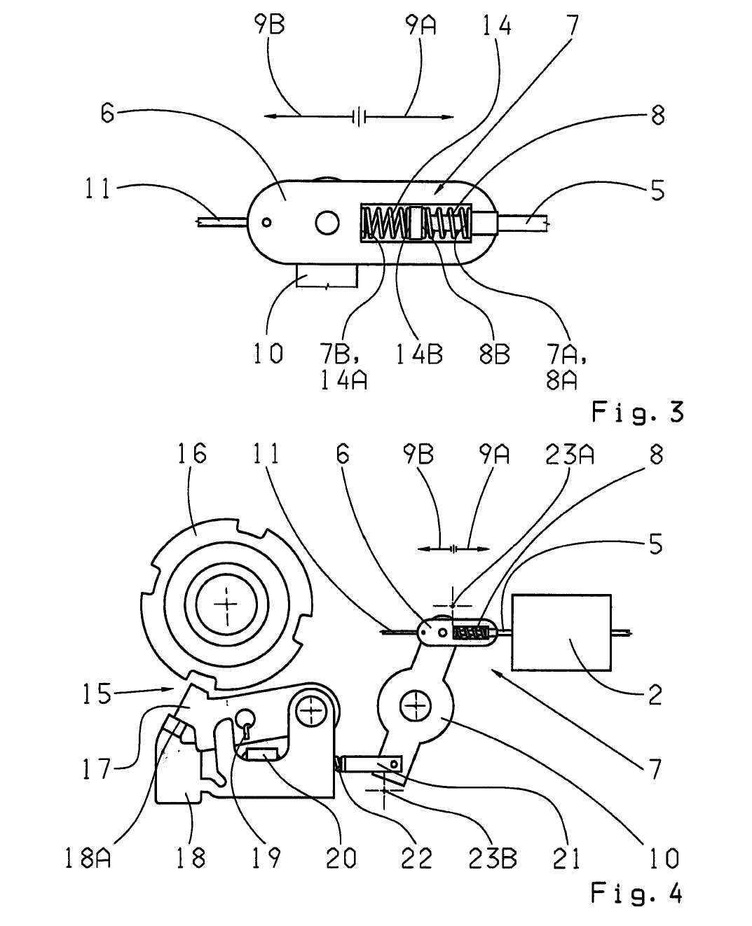

FIG. 3 shows an alternative design of the thrust element 6 in FIGS. 1 and 2. The thrust element 6 shown in FIG. 3 has all the elements of the thrust element 6 in FIGS. 1 and 2, so in FIG. 3 these are given the same indexes as in FIGS. 1 and 2.

However, compared with the thrust element 6 in FIGS. 1 and 2, the thrust element 6 in FIG. 3 has a compression-spring-like second elastic element 14 arranged at least partially in the recess 7, which is in contact with a first end side 14A against the second wall 7B of the recess 7 and which, with a second end side 14B, is in contact against the thickened end area of the first output element 5. The end area of the first output element 5 is thus positioned between the two elastic elements 8, 14. Movement of the first output element 5 in the first direction 9A is thereby transmitted to the thrust element 6 mainly by the first elastic element 8 and movement in the second direction 9B is transmitted to the thrust element 6 mainly by the second elastic element 14. At the same time, in an emergency situation the thrust element 6 can be moved freely by the second output element 11, by compression of the first or second elastic element 8, 14.

On their respective sides 8A, 8B, 14A, 14B, the two elastic elements 8, 14 can also be connected fixed to the thrust element 6 and the first output element 5, so that if the thrust element 6 is moved by the emergency actuation device 12 the spring forces of the two elastic elements 8, 14 are added together. To ensure freedom from play between the first output element 5 and the thrust element 6, this first output element 5 is preferably prestressed between the two elastic elements 8, 14.

FIG. 4 shows an example of the connection of the part of the parking lock mechanism shown in FIGS. 1 and 2 to a mechanical locking device 15. The same elements of the parking lock mechanism of FIGS. 1 and 2 are therefore given the same indexes in FIG. 4.

The mechanical locking device 15 has a parking lock wheel 16 arranged in a rotationally fixed manner on a rotary shaft of a vehicle transmission (not shown), a parking lock pawl 17 mounted to rotate in a housing 18 and stressed by a tension spring 19 against an abutment 18A of the housing, a parking lock cone 20 and a connecting rod 21 connected to the parking lock cone 20 via a compression spring 22. The connecting rod 21, in turn, is connected by a hinge joint to the rotating element 10.

In normal situations the parking lock mechanism is actuated in the disengaging or engaging direction by the actuator 2; the parking lock mechanism illustrated is in its disengaged shift condition.

To actuate it in the engagment direction the first output element 5 is now moved at least approximately in translation in the first direction 9A, whereby the thrust element 6 is also moved by the elastic element 8 from the first position shown, to a second position, so causing the rotating element 10 to rotate clockwise about a bearing point in its central area. This in turn produces an at least approximately translational movement of the connecting rod 21, which by means of the compression spring 22 pushes the parking lock cone between the housing 18 and the parking lock pawl 17, so bringing about movement of the parking lock pawl 17 in the direction of the parking lock wheel 16. Then the parking lock pawl 17 locks into the parking lock wheel 16 in that a lug of the parking lock pawl 17 engages interlockingly in a recess of the parking lock wheel 16, whereby the parking lock mechanism is engaged and is in the locking position. The connection of the parking lock cone 20 to the connecting rod 21 via the compression spring 22 is in this case provided to prevent sticking of the mechanical locking device if the parking lock pawl 17 does not lock into the parking lock wheel 16 immediately.

When the parking lock mechanism is actuated in the disengagement direction, starting from the actuator 2 the movements of the respective components take place in the opposite direction, so the thrust element 6 moves away from the second position and back again to the first position, shown in FIG. 4, and the mechanical locking device 15 reverts to the unlocked state.

If, now, the parking lock mechanism is actuated in the engagement direction but owing to an emergency the actuator 2 does not move, i.e. the first output element 5 can no longer be moved, then by actuating the emergency actuation device 12 shown in FIG. 1 the second output element 11 can be moved in the second direction 9B, so that the thrust element 6 also moves against the spring force of the elastic element 8, which, actuates the mechanical locking device 15 in the disengagement direction as in the normal situation. If from there the parking lock mechanism has to be engaged again, the second output element 11 can be moved to its initial position, whereupon the thrust element 6 is moved back again by the spring force of the first elastic element 8 in the first direction 9A and, thereby, the mechanical locking device 15 is shifted to the locking condition.

If, in an emergency situation, it is desired to actuate the emergency actuation device 12 in the engagement direction instead of the disengagement direction, the bearing point of the rotating element 10 is so arranged that the thrust element 6 and the connecting rod 21 are on an arm of the rotating element common to both and these can therefore be moved exclusively in the same direction. The bearing point can then, for example, be positioned at the points 23A or 23B. In that case the parking lock mechanism is actuated in the engagement direction by movement of the thrust element 6 in the second direction 9B, and actuation in the disengagement direction takes place by movement of the thrust element 6 in the first direction 9A. By actuating the emergency actuation device 15 in an emergency situation, the second output element 11 can then move the thrust element 6 in the second direction 9B, which engages the mechanical locking device 15.

The rotating element 10 can in particular be a selector disk of an automatic transmission (automated vehicle transmission), by means of which gears of the automatic transmission can be selected. The actuator 2 can then also be used for selecting the gears, and the hand-lever 4 is then a selector lever of the type usual in automatic transmissions, with at least one lever position for selecting a transmission mode or a gear, in which the parking lock mechanism is actuated in the disengagement direction, and a lever position for selecting a parking mode, in which the parking lock mechanism is actuated in the engagement direction.

In the designs of the invention shown in FIGS. 1 to 4, when the thrust element 6 is actuated in an emergency situation, to hold it in its respective position against the spring force of the first and/or second elastic element 8, 14, i.e. in order to maintain the engaged or disengaged shift condition of the parking lock mechanism securely in emergency, the emergency actuation device 12 has a releasable catch (not shown) by means of which the second output element 11 can be locked.

### INDEXES

1 Parking lock actuation mechanism
2 Actuator
3 Regulator or control unit
4 Hand-lever
5 First output element
6 Thrust element
7 Recess
7A First wall of the recess 7
7B Second wall of the recess 7
8 Elastic element
8A First side of the elastic element 8
8B Second side of the elastic element 8
9A First direction
9B Second direction
10 Rotating element
11 Second output element
12 Emergency actuation device
13 Hand-lever
14 Second elastic element
14A First side of the elastic element 14
14B Second side of the elastic element 14
15 Mechanical locking device
16 Parking lock wheel
17 Parking lock pawl
18 Housing
18A Housing abutment
19 Parking lock pawl
20 Parking lock cone
21 Connecting rod
22 Compression spring
23A Point
23B Point

1-8. (canceled)

9. A parking lock mechanism for a vehicle transmission comprising:
a mechanical locking device (15);
a movable thrust element (6) being actively connected to the mechanical locking device (15) in such a manner that when the movable thrust element (6) is moved to a first position, the thrust element (6) moves the mechanical locking device (15) to an unlocked condition and when the movable thrust element (6) is moved to a second position, the thrust element (6) moves the mechanical locking device (15) to a locked condition;
a parking lock actuation device (1) with a first movable output element (5);
an emergency actuation device (12) with a second movable output element (11); and
a first elastic element (8),
the first output element (5) being connected, via the first elastic element (8), with the thrust element (6) such that movement of the first output element (5) is transmittable, via the first elastic element (8), to the thrust element (6), and the second output element (11) being directly connected to the thrust element (6),
the thrust element (6) having a recess (7) and the first elastic element (8) being at least partially arranged therein in such a manner that a first side (8A) the first elastic element (8) is in contact with a first wall (7A) of the recess (7) and an opposite, second side (8B) the first elastic element (8) is in contact with the first output element (5).

10. The parking lock mechanism according to claim 9, wherein the thrust element (6) is connected to a selector disk (10) for selecting one of gears and gear ratios of the vehicle transmission, and the selector disk (10) is connected to the mechanical locking device (15).

11. The parking lock mechanism according to claim 9, wherein an end area of the first output element (5) is arranged between the elastic element (8) and a second wall (7B) of the recess (7), opposite the first wall (7A) of the recess (7), in such a manner that movement of the first output element (5) in a first direction (9A) is transmittable to the thrust element (6) by the first elastic element (8), and movement in a second direction (9B) is transmittable to the thrust element (6) directly by the second wall (7B).

12. The parking lock mechanism according to claim 9, wherein:
the parking lock mechanism has a second elastic element (14) arranged at least partially in the recess (7), which with a first side (14A) is in contact with a second wall (7B) of the recess (7), opposite the first wall (7A) of the recess (7), and with a second side (14B) is in contact with the first output element (5), and
an end area of the first output element (5) is arranged between the first and the second elastic elements (8, 14) in such a manner that movement of the first output element (5), in a first direction (9A), is at least partially transmittable via the first output element (5) to the thrust element (6) and movement, in a second direction (9B), is at least partially transmittable by the second elastic element (14) to the thrust element (6).

13. The parking lock mechanism according to claim 9, wherein one of the parking lock actuation device (1) and the emergency actuation device (12) comprises an actuator (2) for moving the first output element (5) or the second output element (11), respectively.

14. The parking lock mechanism according to claim 13, wherein the actuator (2) is one of a hydraulic actuator, a pneumatic actuator and an electro-mechanical actuator.

15. The parking lock mechanism according to claim 9, wherein one of the parking lock actuation device (1) and the emergency actuation device (12) is designed such that movement of either the first or the second output elements (5, 11), respectively, is produced manually by a vehicle operator.

16. A parking lock mechanism in combination with one of an automatic transmission, automated gearshift transmission and a dual-clutch transmission of either a passenger vehicle or a utility vehicle, the parking lock mechanism comprising:
a mechanical locking device (15);
a movable thrust element (6) being actively connected to the mechanical locking device (15) in such a manner that when the movable thrust element (6) is moved to a first position, the thrust element (6) moves the mechanical locking device (15) to an unlocked condition and when the movable thrust element (6) is moved to a second position, the thrust element (6) moves the mechanical locking device (15) to a locked condition;
a parking lock actuation device (1) with a first movable output element (5);
an emergency actuation device (12) with a second movable output element (11); and
a first elastic element (8),
the first output element (5) being connected, via the first elastic element (8), with the thrust element (6) such that movement of the first output element (5) is transmittable, via the first elastic element (8), to the thrust element (6), and the second output element (11) being directly connected to the thrust element (6),
the thrust element (6) having a recess (7) and the first elastic element (8) being at least partially arranged therein in such a manner that a first side (8A) the first elastic element (8) is in contact with a first wall (7A) of the recess (7) and an opposite, second side (8B) the first elastic element (8) is in contact with the first output element (5).

17. A parking lock mechanism for a vehicle transmission, the parking lock mechanism comprising:
a mechanical locking device (15);
a thrust element (6) being axially slidable between first and second positions, the thrust element (6) being connected to the mechanical locking device (15) such that movement of the thrust element (6) to the first position biases the mechanical locking device (15) to an unlocked condition and movement of the thrust element (6) to the second position biases the mechanical locking device (15) to a locked condition, and the thrust element (6) includes a recess (7);
a parking lock actuation device (1) comprising a first output element (5) having an end located within the recess (7) of the thrust element (6);
a first elastic element (8) being located within the recess (7) of the thrust element (6) such that a first end (8A) of the first elastic element (8) contacts a first wall (7A) of the recess (7) and a second end (8B) of the first elastic element (8) contacts the end of the first output element (5), the first elastic element (8) biasing the end of the first output element (5) toward a second wall (7B) of the recess (7), which is opposite the first wall (7A) of the recess (7), such that movement of the first output element (5) being transmitted, via the first elastic element (8), to the thrust element (6); and
an emergency actuation device (12) comprising a second output element (11) being directly connected to the thrust element (6) such that the thrust element (6) being movable by the emergency actuation device (12) via the second output element (11) between the first and the second positions.
